(19) United States
(12) Patent Application Publication
(10) Pub. No.: US 2019/0056052 A1
(43) Pub. Date: Feb. 21, 2019

(54) COOLING DEVICE FOR HIGH TEMPERATURE PIPE

(71) Applicant: Mitsubishi Hitachi Power Systems, Ltd., Yokohama (JP)

(72) Inventors: Takeshi MATSUO, Tokyo (JP); Fumitoshi SAKATA, Yokohama (JP); Yuichi KANEMAKI, Tokyo (JP); Haruki MUKUMOTO, Tokyo (JP); Daigo WATANABE, Tokyo (JP); Chikako KATO, Tokyo (JP); Junichi OZAWA, Yokohama (JP); Junki JOYAMA, Yokohama (JP); Masahiro KUROSE, Yokohama (JP); Takahiro FUJIMORI, Yokohama (JP); Hiroyuki OHYAMA, Yokohama (JP)

(73) Assignee: Mitsubishi Hitachi Power Systems, Ltd., Yokohama (JP)

(21) Appl. No.: 16/080,727

(22) PCT Filed: Feb. 23, 2017
(86) PCT No.: PCT/JP2017/006865

§ 371 Date: Aug. 29, 2018

(30) Foreign Application Priority Data
Mar. 24, 2016 (JP) 2016-060657

(51) Int. Cl. F16L 53/70; F01K 11/02

(52) U.S. Cl. CPC F16L 53/70; F16L 2201/40; F16L 2201/20; F01K 11/02

(57) ABSTRACT

In a cooling device for a high temperature pipe, a high temperature pipe is efficiently cooled, and cooling performance is improved. A cooling device (10) for a high temperature pipe that cools a surface to be cooled (104) of a pipe (100) as a high temperature pipe includes: a cooling medium supply header (11) that is disposed so as not to shield heat dissipation by radiation from the surface to be cooled (104) to the periphery, and allows a cooling medium to flow out toward the surface to be cooled (104); and a cooling medium supply device (12) that supplies the cooling medium to the cooling medium supply header (11).

### TECHNICAL FIELD

The present invention relates to a cooling device for a high temperature pipe used in a plant such as a thermal power plant, an atomic power plant, and a chemical plant.

### BACKGROUND ART

For example, in a thermal power plant, a large number of pipes for conveying steam heated by a boiler to a steam turbine are disposed. These pipes are metallic pipes and allow high temperature and high pressure steam to flow therein. Therefore, they are under environment of a high temperature state heated by this steam. When such metallic pipes are used under the above environment for a long time, creep damage progresses to generate creep voids, and then these creep voids are linked to generate a crack, which is likely to result in fracture.

In order to prevent such fracture of the pipes, the growing degrees of the creep voids are analyzed by regular nondestructive inspection to derive the degree of creep damage, and residual life assessment of the metallic pipes is performed. In this case, the metallic pipes generally have high creep damage risks in welded parts compared to a base material part, and therefore this welded part mainly becomes an inspection object spot. As a result of the nondestructive inspection, in a case where a creep damage risk in a period until next periodic inspection cannot be ignored, the operating temperature of the whole plant is lowered to lower the metal temperatures of the metallic pipes, so that the creep damage risk is reduced. However, if the operating temperature of the whole plant is lowered, there is a disadvantage that operating efficiency of the plant is lowered.

In a case where the creep damage risk in the period until next periodic inspection cannot be ignored, there is provided a method for reducing the creep damage risk by cooling the metallic pipes to lower the metal temperatures. As such a technology, for example, there is a method described in the following PTL 1.

### CITATION LIST

### Patent Literature

[PTL 1]

the Publication of Japanese Patent No. 5701349 (Japanese Unexamined Patent Application, Publication No. 2015-45619)

### SUMMARY OF INVENTION

### Technical Problem

In the above PTL 1, a heat insulating material that covers an outer peripheral part of a high temperature metallic pipe is removed, and a cooling device such as a radiation fin, a cooling pipe, and a supply pipe is disposed in the exposed outer peripheral part of the high temperature metallic pipe to cool the high temperature metallic pipe. However, when the cooling device such as the radiation fin, the cooling pipe, the supply pipe is disposed in the outer peripheral part of the exposed high temperature metallic pipe, heat dissipation by radiation from the high temperature metallic pipe to an ambient low temperature part is shielded, so that cooling efficiency is lowered.

The present invention solves the above problem, and an object of the present invention is to provide a cooling device that attains improvement of cooling performance of a high temperature metallic pipe.

### Solution to Problem

A cooling device for a high temperature pipe of the present invention for achieving the above object is a cooling device for a high temperature pipe installed on a periphery of a surface to be cooled in order to extend life of a high temperature pipe, the cooling device for a high temperature pipe including: a cooling medium supply header that is disposed at such a position as not to shield heat dissipation by radiation from the surface to be cooled to the periphery, and allows a cooling medium to flow out toward the surface to be cooled; and a cooling medium supply device that supplies the cooling medium to the cooling medium supply header.

Therefore, when the cooling medium supply device supplies the cooling medium to the cooling medium supply header, the cooling medium is supplied to this cooling medium supply header, the cooling medium of the cooling medium supply header flows out toward the surface to be cooled, and the high temperature pipe is cooled. At this time, the cooling medium supply header is disposed on the peripheral part of the surface to be cooled except a region facing the surface to be cooled, and therefore the region facing the surface to be cooled becomes an open region. Therefore, heat of the high temperature pipe is dissipated by radiation from the surface to be cooled without being shielded, and the high temperature pipe can be efficiently cooled.

In the cooling device for a high temperature pipe of the present invention, the surface to be cooled is an exposed surface of the high temperature pipe exposed from an uncovered part of a heat insulating material that covers the high temperature pipe, and the cooling medium supply header is disposed outside the surface to be cooled.

Since the surface to be cooled is the exposed surface exposed from the uncovered part of the heat insulating material that covers the high temperature pipe, and the cooling medium supply header is disposed outside the surface to be cooled, the cooling medium supply header does not shield heat dissipation by radiation of the surface to be cooled, and it is possible to effectively cool the surface to be cooled. The heat insulating material is provided between the cooling medium supply header and the high temperature pipe, and it is possible to suppress temperature rise of the cooling medium supply header. Therefore, it is possible to suppress the temperature rise when the cooling medium passes through the cooling medium supply header, and it is possible to effectively cool the surface to be cooled.

In the cooling device for a high temperature pipe of the present invention, the cooling medium supply header is supported on an outer surface of the heat insulating material.

Since the cooling medium supply header is supported on the outer surface of the heat insulating material, a separate member for supporting the cooling medium supply header is unnecessary, and it is possible to simplify the structure.

In the cooling device for a high temperature pipe of the present invention, the cooling medium supply header is supported on the high temperature pipe and an outer surface of the heat insulating material by a support member.

The above structure prevents the cooling medium supply header from falling in the pipe axial direction or the circumferential direction from the high temperature pipe, and therefore the outflow direction of the cooling medium does not change from the surface to be cooled, and initial cooling capacity is maintained, so that it is possible to improve reliability of the cooling device.

The cooling device for a high temperature pipe of the present invention is provided with a cooling medium outflow nozzle that allows the cooling medium of the cooling medium supply header to flow out toward the surface to be cooled.

Since the cooling medium of the cooling medium supply header flows out from the cooling medium outflow nozzle toward the surface to be cooled, the high temperature pipe is cooled. Therefore, heat of the high temperature pipe is dissipated by radiation from the surface to be cooled without being shielded, and the high temperature pipe can be efficiently cooled.

In the cooling device for a high temperature pipe of the present invention, the cooling medium outflow nozzle allows the cooling medium to flow out along the surface to be cooled.

Since the cooling medium is allowed to flow out along the surface to be cooled from the cooling medium outflow nozzle, the cooling medium flows along the surface to be cooled. Therefore, the cooling medium is efficiently supplied to the surface to be cooled, and it is possible to improve cooling efficiency.

In the cooling device for a high temperature pipe of the present invention, the surface to be cooled includes a welded part, and the cooling medium outflow nozzle allows the cooling medium to flow out toward the welded part.

Since the cooling medium is allowed to flow out toward the welded part from the cooling medium outflow nozzle, the cooling medium is directly supplied to the welded part in which a creep damage risk cannot be ignored, and it is possible to efficiently cool the surface to be cooled.

In the cooling device for a high temperature pipe of the present invention, the cooling medium supply header is provided with a cooling medium outlet that allows the cooling medium of the cooling medium supply header to flow out toward the surface to be cooled, the cooling medium supply header has a plate material provided along an uncovered part of a heat insulating material that covers the high temperature pipe, and the cooling medium outlet is formed from both an end of the plate material on a side close to the high temperature pipe and a surface of the high temperature pipe.

Therefore, the velocity distribution and the temperature distribution of the cooling medium flowing out from the cooling medium outlet become maximum on the surface vicinity side of the surface to be cooled compared to a central portion in the height direction of the cooling medium outlet, and velocity gradient and temperature gradient become large on the vicinity of the surface of the high temperature pipe. As a result, compared to a case where the cooling medium outflow nozzle is provided, shear force on the vicinity of the surface of the high temperature pipe becomes large, and a heat transfer coefficient is improved. Therefore, it is possible to effectively cool the surface to be cooled.

In the cooling device for a high temperature pipe of the present invention, the cooling medium supply header has a plate material provided along an uncovered part of a heat insulating material that covers the high temperature pipe, and the plate material has a slit formed therein extending outward from a side close to the high temperature pipe.

The slit provided in the plate material functions as a thermal deformation margin, thereby suppressing the deformation of the cooling medium outlet generated by thermal deformation. As a result, it is possible to suppress lowering of cooling capacity, and improve reliability of the cooling device.

In the cooling device for a high temperature pipe of the present invention, the cooling medium supply header has a plate material provided along an uncovered part of a heat insulating material that covers the high temperature pipe, and the plate material is made up of an assembly of a plurality of division members divided along the high temperature pipe.

Therefore, at a site where the high temperature pipe is installed, the division members of the cooling medium supply header are simply combined, so that the cooling medium supply header forming a ring shape can be easily combined. Therefore, it is possible to reduce a set-up cost.

In the cooling device for a high temperature pipe of the present invention, the cooling medium supply header has a plate material provided along an uncovered part of a heat insulating material that covers the high temperature pipe, and the plate material is made up of an assembly of a plurality of division members divided along the high temperature pipe, and is adjustable in a position of an end of the plate material on a side close to the high temperature pipe.

Therefore, even in a case where the pipe diameter of the high temperature pipe is different, it is only necessary to change a joining position of the division member and extend and contract the plate material having a divided structure without replacing all the plate materials, so that the cooling medium supply header can be easily installed. As a result, it is possible to reduce a set-up cost.

In the cooling device for a high temperature pipe of the present invention, the cooling medium supply header has: a plurality of header units that allow the cooling medium to flow out toward the surface to be cooled while the cooling medium circulates; and extendable parts that are provided between each two of the header units, and the header units and the extendable parts are alternately coupled.

The number of combinations of the plurality of header units and the plurality of extendable parts are determined in accordance with the length along the high temperature pipe, and the length can be freely adjusted. Therefore, in a case where a situation in which the high temperature pipe needs to be promptly cooled occurs, the cooling medium supply header can be quickly installed.

The cooling device for a high temperature pipe of the present invention includes: a temperature sensor that measures a temperature of the cooling medium supplied to the cooling medium supply header by the cooling medium supply device; and a control device that controls an outflow amount of the cooling medium that is allowed to flow out toward the surface to be cooled from the cooling medium outflow nozzle or the cooling medium outlet, in accordance with the temperature of the cooling medium measured by the temperature sensor.

Since the outflow amount of the cooling medium that is allowed to flow out toward the surface to be cooled from the cooling medium outflow nozzle or the cooling medium outlet is controlled in accordance with the temperature of the cooling medium supplied to the cooling medium supply header, the surface to be cooled is always cooled to a temperature required for satisfying required life, which can be maintained, even when the environmental temperature of the periphery is changed.

The cooling device for a high temperature pipe of the present invention includes: a temperature sensor that measures a temperature of the surface to be cooled; and a control device that controls an outflow amount of the cooling medium that is allowed to flow out toward the surface to be cooled from the cooling medium outflow nozzle or the cooling medium outlet, in accordance with the temperature of the surface to be cooled measured by the temperature sensor.

Since the outflow amount of the cooling medium that is allowed to flow out toward the surface to be cooled from the cooling medium outflow nozzle or the cooling medium outlet is controlled in accordance with the temperature of the surface to be cooled, the surface to be cooled is always cooled to a temperature required for satisfying required life, which can be maintained, even when the degree of creep damage of the surface to be cooled, or the environmental temperature of the periphery is changed.

### Advantageous Effects of Invention

According to the cooling device for a high temperature pipe of the present invention, the cooling medium supply header having the cooling medium outflow nozzle is disposed on the peripheral part of the surface to be cooled, and therefore any member for shielding heat dissipation by radiation from the surface to be cooled to the periphery is not disposed. Thus, heat dissipation is effectively performed from the surface to be cooled, so that it is possible to improve cooling performance of the high temperature pipe. Additionally, the heat insulating material is provided between the high temperature pipe and the cooling medium supply header, and it is possible to suppress the temperature rise of the cooling medium supply header. Therefore, it is possible to suppress the temperature rise when the cooling medium passes through the cooling medium supply header, and it is possible to effectively cool the surface to be cooled.

### BRIEF DESCRIPTION OF DRAWINGS

FIG. 1 is a schematic diagram illustrating a cooling device for a high temperature pipe according to a first embodiment.

FIG. 2 is a sectional view taken along II-II of FIG. 1, illustrating the cooling device for a high temperature pipe.

FIG. 3 is a sectional view illustrating a high temperature pipe.

FIG. 4 is a sectional view of the pipe having a partially removed heat insulating material.

FIG. 5 is a schematic diagram illustrating a first modification of the cooling device for a high temperature pipe according to the first embodiment.

FIG. 6 is a sectional view taken along VI-VI of FIG. 5, illustrating the cooling device for a high temperature pipe.

FIG. 7 is a sectional view illustrating a high temperature pipe.

FIG. 8 is a sectional view of the pipe having a partially removed heat insulating material.

FIG. 9 is a partially enlarged sectional view illustrating the first modification of the cooling device for a high temperature pipe according to the first embodiment.

FIG. 10 is a front view illustrating a second modification of the cooling device for a high temperature pipe according to the first embodiment.

FIG. 11 is a partially enlarged front view illustrating the second modification of the cooling device for a high temperature pipe according to the first embodiment.

FIG. 12 is a sectional view in the pipe axial direction illustrating the second modification of the cooling device for a high temperature pipe according to the first embodiment.

FIG. 13 is a partially enlarged longitudinal sectional view illustrating the second modification of the cooling device for a high temperature pipe according to the first embodiment.

FIG. 14 is a graph illustrating relation between a heat transfer ratio and a guide length.

FIG. 15 is a front view illustrating a modification of a plate material of the second modification of the cooling device for a high temperature pipe according to the first embodiment.

FIG. 16 is a sectional view in the pipe axial direction illustrating the modification of the plate material of the second modification of the cooling device for a high temperature pipe according to the first embodiment.

FIG. 17 is a front view illustrating the modification of the plate material of the second modification of the cooling device for a high temperature pipe according to the first embodiment.

FIG. 18 is a front view illustrating a third modification of the cooling device for a high temperature pipe according to the first embodiment.

FIG. 19 is a perspective view illustrating the third modification of the cooling device for a high temperature pipe according to the first embodiment.

FIG. 20 is a schematic diagram illustrating a cooling device for a high temperature pipe of a second embodiment.

FIG. 21 is a schematic diagram illustrating a first modification of the cooling device for a high temperature pipe of the second embodiment.

### DESCRIPTION OF EMBODIMENTS

Hereinafter, preferred embodiments of a cooling device for a high temperature pipe according to the present invention will be described in detail with reference to the attached drawings. The present invention is not limited to these embodiments, and includes a combination of embodiments if there is a plurality of embodiments.

### First Embodiment

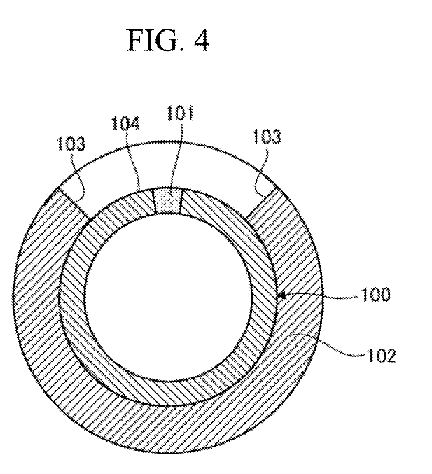

FIG. 3 is a sectional view illustrating a high temperature pipe, and FIG. 4 is a sectional view of the pipe having a partially removed heat insulating material.

In the first embodiment, the high temperature pipe is a metallic steam pipe that conveys, to a steam turbine, steam heated by a boiler, in a thermal power plant, for example, and is a high temperature metallic pipe heated by high temperature and high pressure steam that flows therein. Nondestructive inspection for this metallic pipe is performed on a regular basis, the growing degrees of creep voids of the pipe are analyzed to derive the degree of creep damage, and residual life assessment of the pipe is performed. In a case where the creep damage risk in a period until next periodic inspection cannot be ignored, the high temperature metallic pipe is cooled to lower the temperature, so that the creep damage risk is reduced.

In a cooling device for a high temperature pipe of this embodiment, an exposed surface of the pipe exposed to the outside from an uncovered part of a heat insulating material that covers the high temperature pipe is a surface to be cooled, and cools this surface to be cooled. A welded part of the metallic pipe has higher creep damage risk than a base material part, and therefore the periphery of this welded part is mainly set to an object to be cooled.

First, an arrangement state of the high temperature pipe will be described. As illustrated in FIG. 3, a high temperature metallic pipe 100 is, for example, a steam pipe used in a plant such as a thermal power plant, an atomic power plant, and a chemical plant. This metallic pipe 100 allows high temperature and high pressure fluid (for example, steam) to flow therein, so that the metallic pipe is constantly under high temperature and high pressure environment. This metallic pipe 100 is an electric resistance welded tube provided with a welded part 101 along the axial direction, and an outer surface of the metallic pipe 100 is covered with a heat insulating material 102 for suppressing fluid temperature reduction of high temperature and high pressure fluid.

When the metallic pipe 100 is used under the high temperature environment for a long time, creep damage progresses to generate creep voids, and then these creep voids are linked to generate a crack, which is likely to result in fracture. In order to prevent this fracture, the growing degrees of the creep voids are analyzed by regular nondestructive inspection to derive the degree of creep damage of each part, and residual life assessment of the pipe 100 is performed. More specifically, as illustrated in FIG. 4, the heat insulating material 102 that covers the vicinity of the welded part 101 in which the creep damage risk cannot be ignored is removed to form an uncovered part 103, exposing a surface to be cooled 104 including the welded part 101, which is cooled by the cooling device of this embodiment.

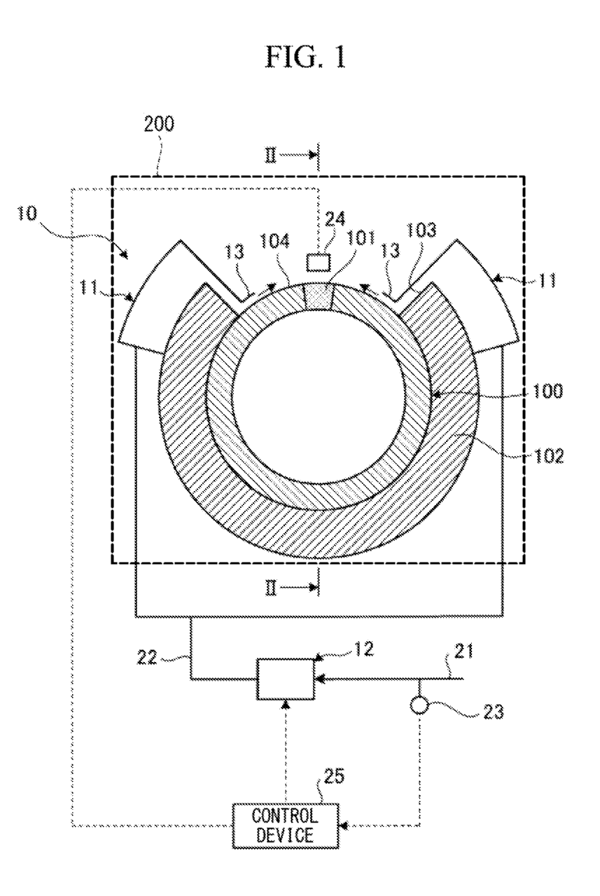

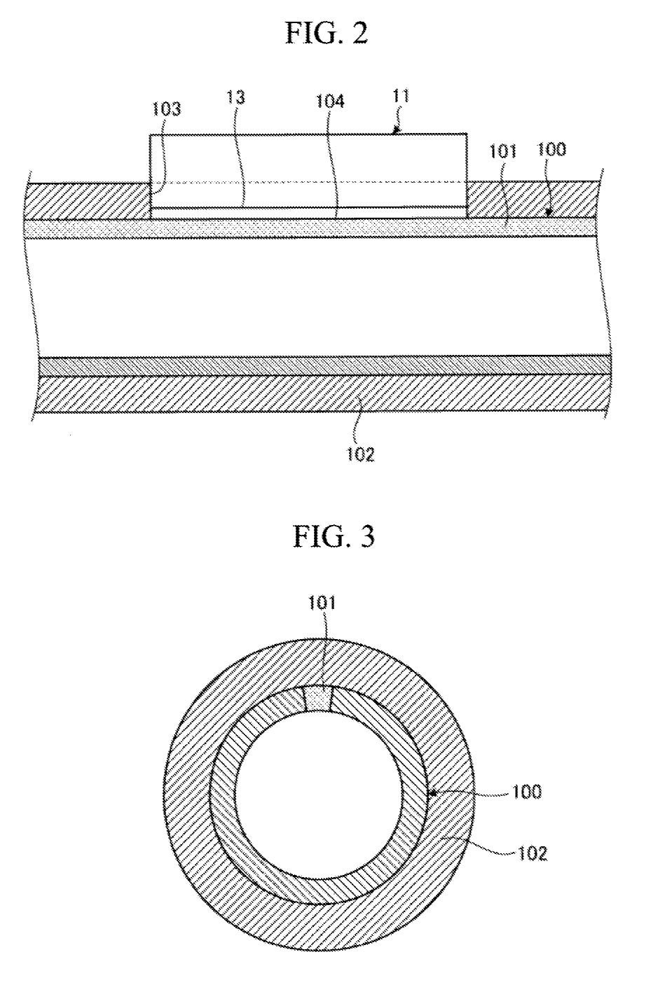

FIG. 1 is a schematic diagram illustrating the cooling device for a high temperature pipe according to the first embodiment, and FIG. 2 is a sectional view taken along II-II of FIG. 1, illustrating the cooling device for a high temperature pipe.

In the first embodiment, as illustrated in FIG. 1 and FIG. 2, a cooling device 10 for a high temperature pipe is a device that cools the surface to be cooled 104 of the metallic pipe (high temperature pipe) 100, and includes cooling medium supply headers 11, a cooling medium supply device 12, cooling medium outflow nozzles 13, and a rain protection hood 200. In FIG. 1, the hood 200 is illustrated by a broken line, and the hood 200 is installed so as to cover the cooling device 10 and the pipe 100.

The cooling medium supply headers 11 are disposed outside the heat insulating material 102 on both sides along the surface to be cooled 104, that is, on both sides shifted in the circumferential direction of the pipe 100 with respect to the surface to be cooled 104, so as not to shield heat dissipation by radiation from the surface to be cooled 104 of the pipe 100. The cooling medium supply headers 11 do not limited to the case where the cooling medium supply headers are disposed outside the heat insulating material 102, and only need to be disposed outside the surface to be cooled 104. For example, the heat insulating material 102 may be cut out and the cooling medium supply headers 11 may be disposed in the heat insulating material 102.

The respective cooling medium supply headers 11 include the cooling medium outflow nozzles 13 on facing sides such that the cooling medium outflow nozzles 13 face each other. The cooling medium outflow nozzles 13 extend toward an outer peripheral surface of the pipe 100 along end surfaces of the heat insulating material 102 formed from this uncovered part 103 on sides close to the uncovered part 103 of the cooling medium supply headers 11, and have tip parts bent along the surface to be cooled 104 that is the outer peripheral surface of the pipe 100. Therefore, the respective cooling medium outflow nozzles 13 are disposed such that outlets face each other, and allow cooling mediums to flow out along the surface to be cooled 104. The cooling medium outflow nozzles 13 are provided along the axial direction of the pipe 100 in the uncovered part 103.

The cooling medium supply device 12 is a fan or a blower, and supplies the cooling medium to each cooling medium supply header 11. The cooling medium supply device 12 is coupled up to the intake pipe 21, and is coupled up to the cooling medium supply headers 11 through a supply pipe 22. Therefore, the cooling medium supply device 12 supplies the cooling medium taken from the intake pipe 21 to the cooling medium supply headers 11 by the supply pipe 22.

The intake pipe 21 is provided with a first temperature sensor 23 that measures the temperature of the cooling medium flowing therein. Additionally, a second temperature sensor 24 that measures the temperature of the surface to be cooled 104 of the pipe 100 is provided. In a case where a metallic pipe is measured by a temperature sensor that directly measures a thermocouple or the like, the temperature sensor is mounted on the metallic pipe by welding. At this time, there is a possibility that a contaminant that becomes a factor of generating voids is mixed in the metallic pipe. In order to suppress this, a non-contact sensor such as a radiation thermometer that does not require welding is desirable as the second temperature sensor 24. The cooling medium temperature measured by the first temperature sensor 23 is input to the control device 25, and the temperature of the surface to be cooled 104, measured by the second temperature sensor 24, is input to the control device 25. The control device 25 controls a cooling medium supply amount supplied to the cooling medium supply headers 11 by the cooling medium supply device 12 in accordance with the cooling medium temperature measured by the first temperature sensor 23, and controls the cooling medium supply amount supplied to the cooling medium supply headers 11 by the cooling medium supply device 12 in accordance with the temperature of the surface to be cooled 104, measured by the second temperature sensor 24. When the cooling medium supply amount supplied to the cooling medium supply headers 11 by the cooling medium supply device 12 is controlled, the cooling medium supply amount to be supplied to the surface to be cooled 104 from each of the cooling medium outflow nozzles 13 is controlled.

That is, the surrounding environment of the installed metallic pipe 100 periodically changes per day in a season cycle. There is a possibility that the metal temperatures of the surface to be cooled 104 and the welded part 101 of the metallic pipe 100 to be cooled are changed due to this air temperature change, and required life prolongation of the pipe 100 is not obtained. As a countermeasure, even with the temperature change, the cooling medium supply amount to be supplied to the surface to be cooled 104 is controlled such that the metal temperature of the welded part 101 of the pipe 100 is kept constant.

When the cooling medium supply device 12 is thus operated, the cooling medium is taken in through the intake pipe 21, the cooling medium is supplied to the respective cooling medium supply headers 11 through the supply pipe 22. Each cooling medium supply header 11 allows the cooling medium to flow out from each cooling medium outflow nozzle 13 along the surface to be cooled 104. As a result, the welded part 101 is cooled by the cooling medium flowing along the surface to be cooled 104. At this time, the control device 25 controls the cooling medium supply amount to be supplied to the cooling medium supply headers 11 by the cooling medium supply device 12 in accordance with the cooling medium temperature and the temperature of the surface to be cooled 104, and controls the cooling medium supply amount to be supplied from the cooling medium outflow nozzles 13 to the surface to be cooled 104.

As a result, even when the ambient air temperature of the metallic pipe 100 changes, the welded part 101 of the pipe 100 can be controlled to the metal temperature that satisfies required lifetime.

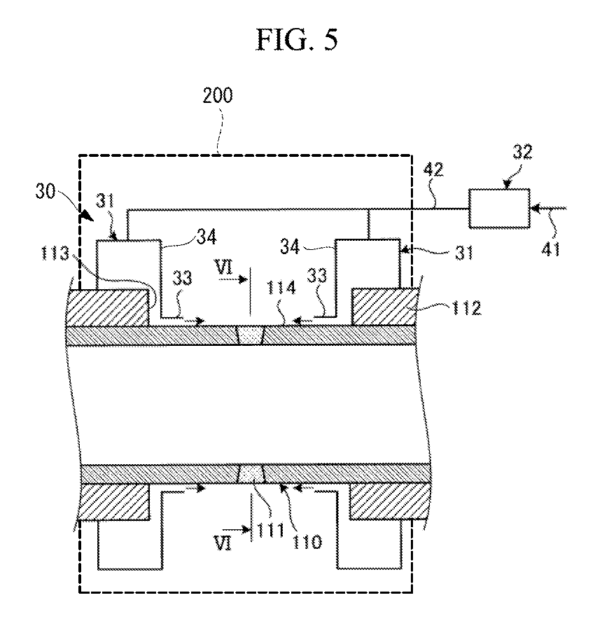

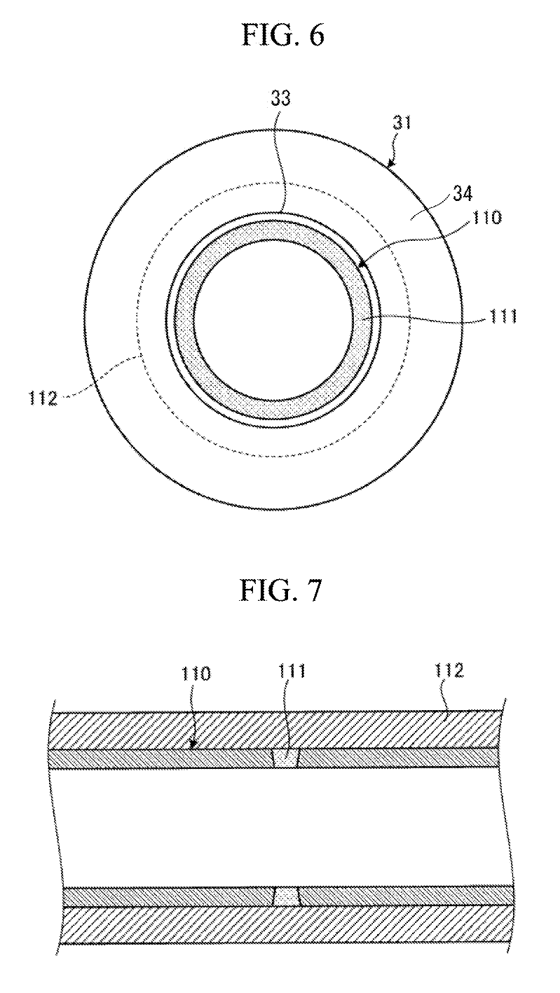

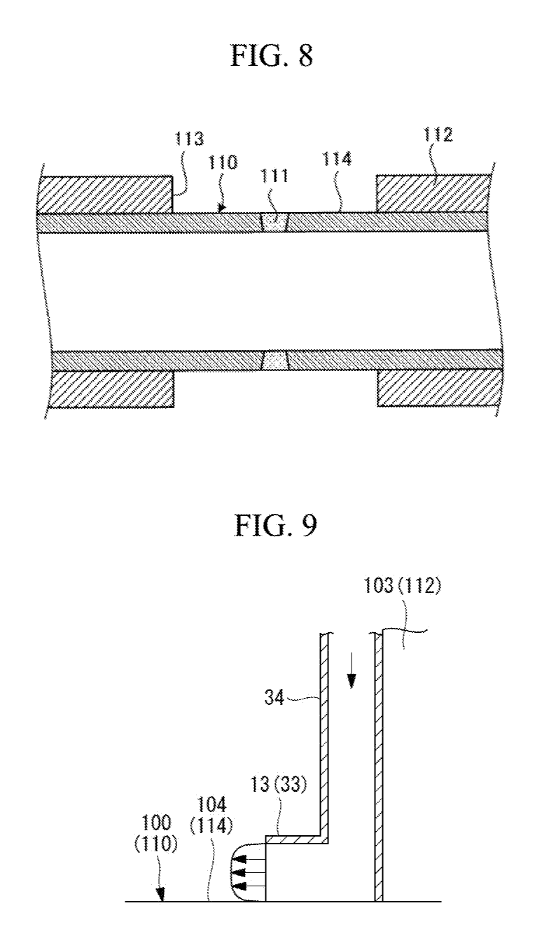

The metallic pipe 100 is the electric resistance welded tube having the welded part 101 along the axial direction of the metallic pipe 100 in the above embodiment, but is not limited to this configuration. That is, as to a case where the welded part 101 is provided in the circumferential direction of the metallic pipe 100, a schematic diagram illustrating a first modification of the cooling device for a high temperature pipe according to the first embodiment is illustrated in FIG. 5, a sectional view taken along VI-VI of FIG. 5, illustrating the cooling device for a high temperature pipe is illustrated in FIG. 6, a sectional view of a high temperature pipe is illustrated in FIG. 7, and a sectional view of the pipe having a partially removed heat insulating material is illustrated in FIG. 8.

In the first modification, as illustrated in FIG. 7, a high temperature metallic pipe 110 is a connecting pipe provided with a welded part 111 along the circumferential direction, and the periphery is covered with a heat insulating material 112 in order to suppress reduction of the plant efficiency.

When the metallic pipe 110 is used under high temperature environment for a long time, creep damage progresses to generate creep voids, and then these creep voids are linked to generate a crack, which is likely to result in fracture. In order to prevent this fracture, the growing degrees of the creep voids are analyzed by regular nondestructive inspection to derive the degree of creep damage of each part, and residual life assessment of the pipe 110 is performed. More specifically, as illustrated in FIG. 8, the heat insulating material 112 that covers the vicinity of the welded part 111 in which the creep damage risk is high is removed to form an uncovered part 113, exposing a surface to be cooled 114 including the welded part 111, and the surface to be cooled 114 is cooled by the cooling device of this embodiment.

As illustrated in FIG. 5 and FIG. 6, a cooling device 30 for a high temperature pipe is a device that cools the surface to be cooled 114 of the metallic pipe (high temperature pipe) 110, and includes cooling medium supply headers 31, a cooling medium supply device 32, cooling medium outflow nozzles 33, and a hood 200.

The cooling medium supply headers 31 are disposed outside the heat insulating material 112 on both sides along the pipe axial direction of the surface to be cooled 114, that is, on both sides shifted in the pipe axial direction of the pipe 110 with respect to the surface to be cooled 114, so as not to shield heat dissipation by radiation from the surface to be cooled 114 of the pipe 110. The cooling medium supply headers 31 do not limited to the case where the cooling medium supply headers are disposed outside the heat insulating material 112, and only need to be disposed outside the surface to be cooled 114. The heat insulating material 112 may be cut out and the cooling medium supply headers 31 may be disposed in the heat insulating material 112.

The cooling medium supply headers 31 form similar hollow box shapes, and are disposed on both side of the uncovered part 113 on the outer peripheral surface of the heat insulating material 112, so as to form ring shapes along the circumferential direction.

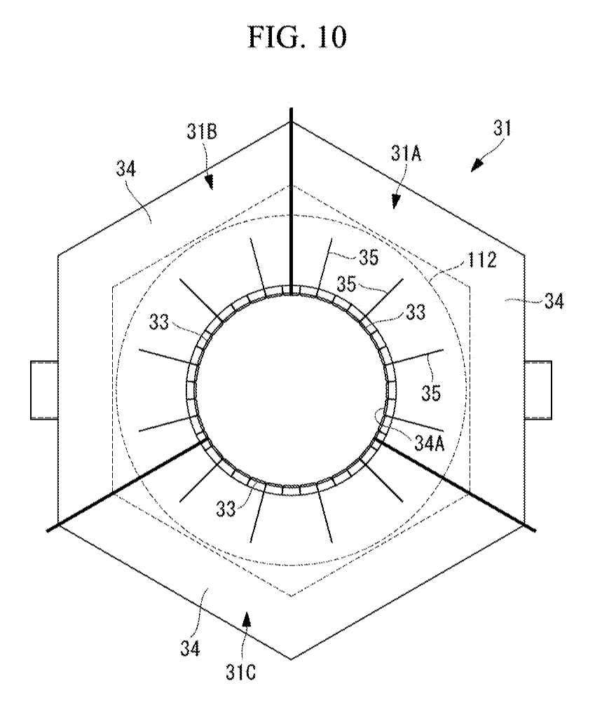

As illustrated in FIG. 10, the cooling medium supply headers 31 may each have a configuration enabling division into a plurality of pieces in the circumferential direction. In FIG. 10, each cooling medium supply header 31 is divided into three, and is composed of division members 31A, 31B, 31C. The division members 31A, 31B, 31C are joined to each other by bolts, for example. Consequently, at a site where the pipe 110 is installed, the division members 31A, 31B, 31C of each cooling medium supply header 31 are simply combined, so that the cooling medium supply headers 31 forming the ring shapes can be easily installed. Therefore, it is possible to reduce a set-up cost.

As illustrated in FIG. 5, in the cooling medium supply headers 31, the cooling medium outflow nozzles 33 are provided so as to face each other. The cooling medium outflow nozzles 33 extend toward an outer peripheral surface of the pipe 110 along end surfaces of the heat insulating material 112 forming this uncovered part 113 on sides close to the uncovered part 113 of the cooling medium supply headers 31, and have tip parts bent along the surface to be cooled 104 that is the outer peripheral surface of the pipe 100. Therefore, the respective cooling medium outflow nozzles 33 are disposed such that outlets face each other, and allow cooling mediums to flow out along the surface to be cooled 114. The cooling medium outflow nozzles 33 are provided along the whole area in the circumferential direction of the pipe 110 in the uncovered part 113.

The cooling medium supply headers 31 have plate materials 34 that extend toward the outer peripheral surface of the pipe 110 along the end surfaces of the heat insulating material 112 forming this uncovered part 113 of the cooling medium supply headers 31 on the sides close to the uncovered part 113. Plate surfaces of the plate materials 34 are disposed in the direction substantially perpendicular to the pipe axial direction of the pipe 110. As illustrated in FIG. 10, the plate materials 34 may have slits 35 formed therein extending outward from the vicinity of the surface of the pipe 110.

Tips on sides close to the pipe 110 of the cooling medium supply headers 31 are in contact with a high temperature portion, and therefore the temperature of each tip rises up to the outer surface temperature (about 500° C. to 550° C.) of the pipe 110. However, a cooling medium supply source side of each cooling medium supply header 31 is an almost room temperature, and therefore temperature difference of about 500° C. is generated in the height direction of each plate material 34. As a result, thermal deformation of several millimeters generates in the tips, on the sides closer to the pipe 110, of the cooling medium supply headers 31. Due to this thermal deformation, the outflow velocity of the cooling medium is locally lowered, and therefore the temperature of the surface to be cooled 114 becomes uneven. As a result, remaining life of the welded part 111 becomes uneven, and therefore reliability of the plant is lowered.

On the other hand, the slits 35 are provided in the plate materials 34, so that the slits 35 each function as a thermal deformation margin generated in the tip close to the pipe 110 of each cooling medium supply header 31. Therefore, it is possible to suppress the thermal deformation of the tips. As a result, it is possible to suppress unevenness of the outflow velocity of each cooling medium, and improve the reliability of the plant. The slits 35 are provided at a plurality of portions at a predetermined interval.

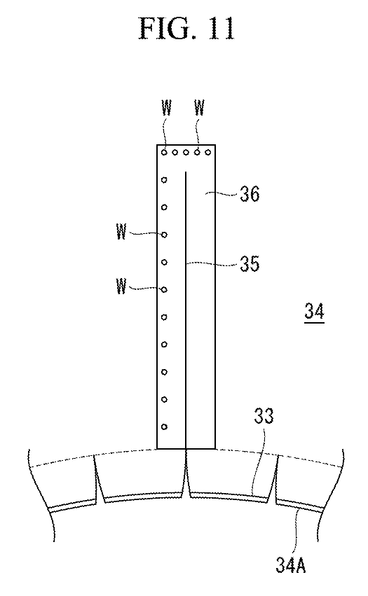

In order to prevent the cooling medium from leaking from the slits 35, seal materials such as metallic foil 36 are desirably provided along the slits 35, as illustrated in FIG. 11. The metallic foil 36 is installed on an inner surface side of each cooling medium supply header 31 in which the cooling medium circulates. For example, only one side of each slit 35 is fixed to each plate material 34 along the slit 35 by spot welding such that the plate material 34 is not restricted by the metallic foil 36. In FIG. 11, welded portions are illustrated by reference symbol W. When the cooling medium is supplied to the cooling medium supply headers 31, internal pressure rises, and therefore the metallic foil 36 and the plate materials 34 are closely adhered, and leakage of the cooling medium is suppressed.

The cooling medium supply device 32 illustrated in FIG. 5 is a fan or a blower, and supplies the cooling medium to each cooling medium supply header 31. The cooling medium supply device 32 is coupled to the intake pipe 41, and is coupled to the respective cooling medium supply headers 31 through a supply pipe 42. Therefore, the cooling medium supply device 32 supplies the cooling medium taken from the intake pipe 41 to the respective cooling medium supply headers 31 by the supply pipe 42.

Although not illustrated, in this first modification, similarly to the first embodiment, the first temperature sensor 23, the second temperature sensor 24, and the control device 25 may be provided, and the cooling medium supply device 32 may control the cooling medium supply amount to be supplied to the cooling medium supply headers 31 in accordance with the cooling medium temperature or the temperature of the surface to be cooled 114.

Therefore, when the cooling medium supply device 32 is operated, the cooling medium is taken in through the intake pipe 41, the cooling medium is supplied to the respective cooling medium supply headers 31 through the supply pipe 42. Each cooling medium supply header 31 allows the cooling medium to flow out from the cooling medium outflow nozzle 33 along the surface to be cooled 114.

As a result, it is possible to form a flow of the cooling medium along the surface to be cooled 114 to effectively cool the welded part 111.

Thus, according to the cooling devices for a high temperature pipe of the first embodiment, the cooling devices are provided for the pipes installed on peripheries of the surfaces to be cooled 104, 114, so as to cool the surfaces to be cooled 104, 114 of the pipes 100, 110 as the high temperature pipes in order to extend the life of the pipes 100, 110. The cooling devices include the cooling medium supply headers 11, 31 that are disposed such positions as not to shield heat dissipation by radiation from the surfaces to be cooled 104, 114, and allow the cooling mediums to flow out toward the surfaces to be cooled 104, 114, the cooling medium supply devices 12, 32 that supply the cooling mediums to the cooling medium supply headers 11, 31, and the cooling medium outflow nozzles 13, 33 that allow the cooling mediums of the cooling medium supply headers 11, 31 to flow out toward the surfaces to be cooled 104, 114.

When the cooling medium supply devices 12, 32 supply the cooling mediums to the cooling medium supply headers 11, 31, the cooling mediums are supplied to these cooling medium supply headers 11, 31, and the respective cooling mediums of the cooling medium supply headers 11, 31 flow out from the cooling medium outflow nozzles 13, 33 toward the surfaces to be cooled 104, 114. Then, the surfaces to be cooled 104, 114 of the pipes 100, 110 are effectively cooled.

At this time, the cooling medium supply headers 11, 31 are disposed so as not to shield heat dissipation by radiation from the surfaces to be cooled 104, 114, and therefore the outsides of the surfaces to be cooled 104, 114 have open spaces with respect to the peripheries. Heat dissipation amounts by radiation are thus maximized, and therefore it is possible to suppress the cooling medium amounts, and effectively cool the pipes 100, 110 to improve cooling performance.

In the cooling devices for a high temperature pipe of the first embodiment, the cooling medium supply headers 11, 31 are disposed outside the heat insulating materials 102, 112. As a result, it is possible to suppress temperature rise when the respective cooling mediums pass through the cooling medium supply headers 11, 31, and it is possible to effectively cool the surfaces to be cooled 104, 114.

In the cooling devices for a high temperature pipe of the first embodiment, the cooling medium supply headers 11, 31 are supported on outer surfaces of the heat insulating materials 102, 112. Therefore, separate members for supporting the cooling medium supply headers 11, 31 are unnecessary, and it is possible to attain simplification of the structures.

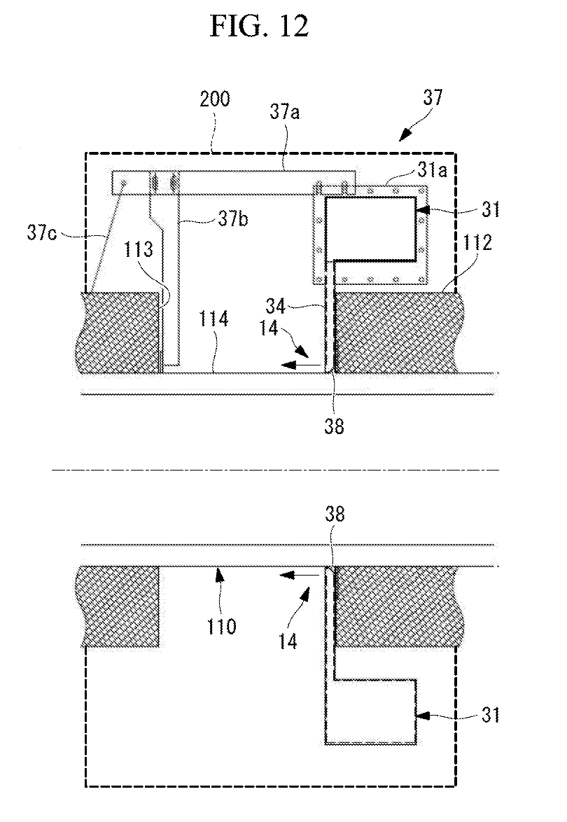

In a case where the cooling medium supply headers 11, 31 are installed on only one sides, support materials may be installed in order to prevent falling. As an example of the case of the cooling medium supply headers 31, a support material 37 has a first member 37a in parallel to the pipe axial direction, a second member 37b installed in the direction substantially perpendicular to the pipe axial direction, and a wire material 37c connecting the second member 37b and the heat insulating material 112, as illustrated in FIG. 12. The first member 37a has a first end connected to a flange part 31a of the cooling medium supply headers 31, and a second end connected to the wire material 37c. The second member 37b has a first end connected to the pipe 110, and a second end connected to the first member 37a. In a case of the cooling medium supply headers 31, falling in the pipe axial direction of the pipe 110 can be prevented by the first member 37a and the second member 37b, and falling in the circumferential direction of the pipe 110 can be prevented by wire material 37c. Since the falling of the cooling medium supply headers is prevented, the outflow direction of the cooling medium does not change from the surface to be cooled, and initial cooling capacity is maintained, so that it is possible to improve reliability of the cooling device.

In the cooling devices for a high temperature pipe of the first embodiment, the cooling medium outflow nozzles 13, 33 allow the respective cooling mediums to flow out along the surfaces to be cooled 104, 114. Therefore, the whole amounts of the respective cooling mediums can be used to cool the surfaces to be cooled 104, 114, and it is possible to improve cooling efficiency of the surfaces to be cooled 104, 114.

In the cooling devices for a high temperature pipe of the first embodiment, the cooling medium supply headers 11, 31 are disposed on the both sides along the surfaces to be cooled 104, 114, and the cooling medium outflow nozzles 13, 33 are provided so as to face. Therefore, the respective cooling mediums are supplied from the both sides with respect to the surfaces to be cooled 104, 114, and to cool the surfaces, and it is possible to increase the cooling medium supply amounts to improve the cooling efficiency. In the cooling devices for a high temperature pipe of the first embodiment, the cooling medium supply headers 11, 31 are disposed on the both sides along the surfaces to be cooled 104, 114. However, in a case where the high temperature pipes are small diameter pipes, the cooling medium supply headers 11, 31 may be disposed on the only one sides.

The cooling devices for a high temperature pipe of the first embodiment include the respective first temperature sensors 23 that measure the cooling medium temperatures supplied to the cooling medium supply headers 11, 31 by the cooling medium supply devices 12, 32, and the respective control devices 25 that control the outflow amounts of the cooling mediums allowed to flow out toward the surfaces to be cooled 104, 114 from the cooling medium outflow nozzles 13, 33 in accordance with the cooling medium temperatures measured by the first temperature sensors 23. Since the outflow amounts of the cooling mediums allowed to flow out toward the surfaces to be cooled 104, 114 from the cooling medium outflow nozzles 13, 33 are controlled in accordance with the cooling medium temperatures, it is possible obtain required life extension effects to improve reliability of the plant without being influenced by an ambient air temperature.

The cooling devices for a high temperature pipe of the first embodiment include the respective second temperature sensors 24 that measure the temperatures of the surfaces to be cooled 104, 114, and the respective control devices 25 that control the outflow amounts of the cooling mediums allowed to flow out toward the surfaces to be cooled 104, 114 from the cooling medium outflow nozzles 13, 33 in accordance with the temperatures of the surfaces to be cooled 104, 114, the temperatures being measured by the second temperature sensors 24. Since the outflow amounts of the cooling mediums allowed to flow out toward the surfaces to be cooled 104, 114 from the cooling medium outflow nozzles 13, 33 are controlled in accordance with the temperatures of the surfaces to be cooled 104, 114, it is possible to consider the progress of the creep damage of the surfaces to be cooled 104, 114 or the ambient air temperatures, and it is possible obtain required life extension effects to improve reliability of the plant.

In the cooling medium supply headers 11, 31, description has been made to the case where the cooling medium outflow nozzles 13, 33 are provided. However, the present invention is not limited to these examples.

In the above first embodiment and first modification, the tip parts of the cooling medium outflow nozzles 13, 33 are bent along the surfaces to be cooled 104, 114 that are the outer peripheral surfaces of the pipes 100, 110. Therefore, as illustrated in FIG. 9, velocity distribution and temperature distribution of the cooling mediums flowing out from the tip parts are parabolic, shear force near each of the surfaces to be cooled 104, 114 is relatively small, and a heat transfer coefficient between the surface of each of the pipes 100, 110 and the cooling medium is small.

On the other hand, in the second modification, respective outflow parts are provided in the cooling medium supply headers 11, 31 in place of the cooling medium outflow nozzles 13, 33.

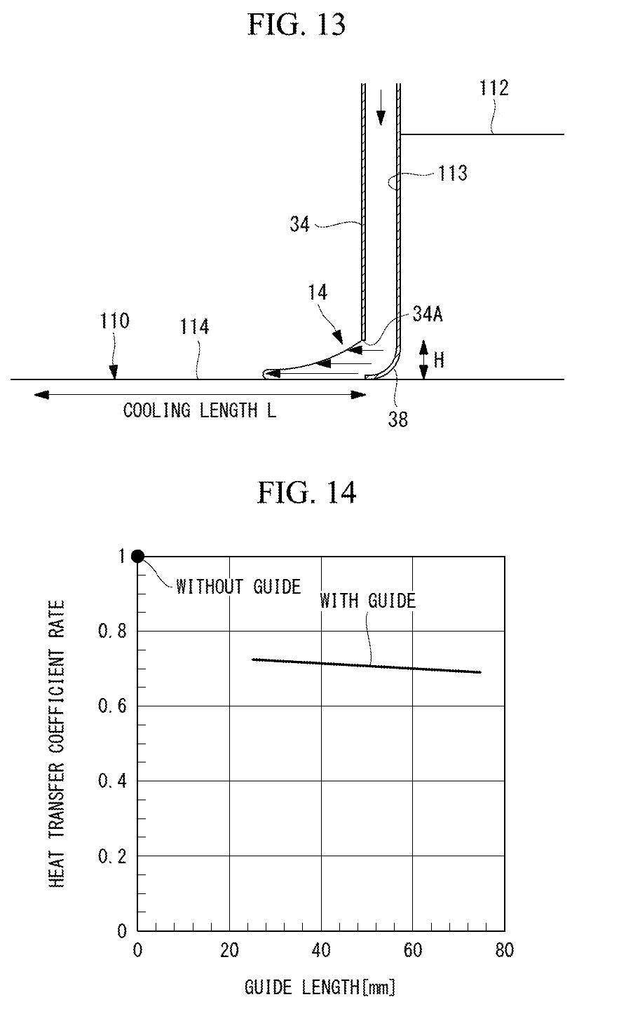

In the cooling medium supply header 31, an outflow part 14 is provided, as illustrated in FIG. 12 and FIG. 13. The outflow part 14 has a plate material 34 extending toward the outer peripheral surface of the pipe 110 along the end surface of the heat insulating material 112 provided with the uncovered part 113 of the cooling medium supply header 31 on the side close to the uncovered part 113. An outlet of the outflow part 14 is formed from an end 34A facing the pipe 110 of the plate material 34, and the surface of the pipe 110. The outlet of the outflow part 14 is provided along the circumferential direction of the pipe 110 in the uncovered part 113, and the cooling medium flows out along the surface to be cooled 114.

Consequently, the velocity distribution and the temperature distribution of the cooling medium flowing out from the outlet of the outflow part 14 become maximum on the surface vicinity side of the surface to be cooled 114 compared to a central portion in the height direction of the outlet, as illustrated in FIG. 13, and velocity gradient and temperature gradient become large in the vicinity of the surface of the pipe 110. As a result, compared to a case where the cooling medium outflow nozzle 13 is provided, shear force on the vicinity of the surface of the pipe 110 become large, and the heat transfer coefficient is increased. Therefore, it is possible to effectively cool the surface to be cooled 114.

The outflow part 14 may be provided with a curved part 38 having a circular arc-shaped cross-section inside the outlet, that is, in the vicinity of an intersection of the end surface of the heat insulating material 112 and the surface of the pipe 110. The curved part 38 projects from the end surface of the heat insulating material 102 toward the outlet of the outflow part 14, as approaching the pipe 110. Since the curved part 38 is provided, the velocity gradient and the temperature gradient of the cooling medium flowing out from the outlet of the outflow part 14 can be further increased in the vicinity of the surface of the pipe 110, and it is possible to more effectively cool the surface to be cooled 114.

As illustrated in FIG. 13, relation between the height of the outlet H, and the cooling length L that is a distance from the outlet to the welded part 111 of the object to be cooled is L/H≈10 to 20. In a case of this range, the flow velocity of the cooling medium is maintained, and therefore it is possible to obtain a high heat transfer coefficient in the welded part 111.

In the above, description has been made to the case where the outflow part 14 is provided in place of the cooling medium outflow nozzle 33 of the first modification. However, a configuration similar to the outflow part 14 can be provided in place of the cooling medium outflow nozzle 13 according to the first embodiment.

For example, FIG. 14 illustrates a difference in a heat transfer coefficient between a case where the cooling medium outflow nozzles 13, 33 are provided and protruding guides are formed along the pipes 100, 110, and a case where no guide is provided like the outflow part 14.

In FIG. 14, a heat transfer coefficient in a case where the guide lengths of the cooling medium outflow nozzles 13, 33 are in a rage of about 25 mm to 75 mm is compared with a heat transfer coefficient in a case where the outflow part 14 with no guide is provided. As illustrated in FIG. 14, in the cooling medium outflow nozzles 13, 33 provided with the guides, the heat transfer coefficient lowers up to about 70% compared to the outflow part 14 with no guide, and it is found that the heat transfer coefficient of the outflow part 14 with no guide is more improved.

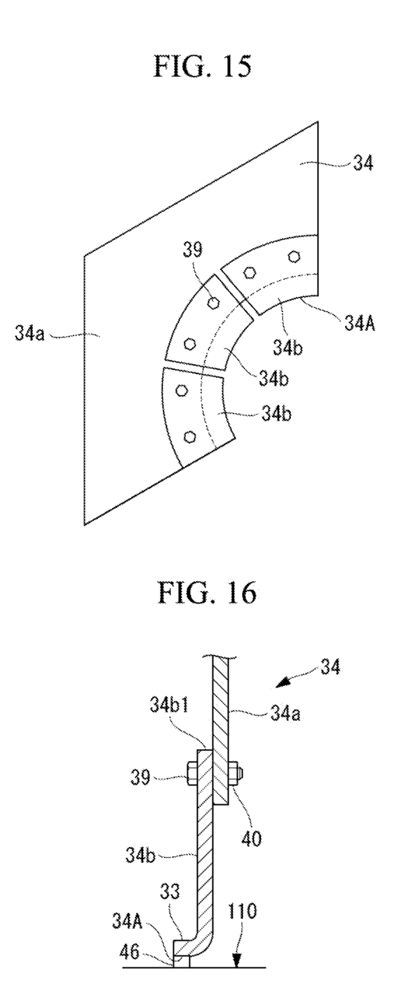

As illustrated in FIG. 10, the plate material 34 provided in each cooling medium supply header 31 is divided into a plurality of members along the circumferential direction, and may be divided into a plurality of members along the radial direction of the pipe 110, as illustrated in FIG. 15 and FIG. 16. The plate material 34 is divided into a division member 34a disposed on the cooling medium supply source side, and division members 34b disposed on the pipe 110 side along the radial direction. The division members 34a, 34b are joined to each other by bolts 39 and nuts 40, for example. Joining positions of the division members 34b with respect to the division member 34a are changed, so that even in a case where the pipe diameter of the pipe 110 is different, the cooling medium supply header 31 can be installed by simply extending and contracting the plate material 34 having a divided structure without replacing all the plate materials 34. As illustrated in FIG. 15, for example, the division members 34b each have a fan shape, having a longer length in the circumferential direction on the cooling medium supply source side and a shorter length in the circumferential direction on the pipe side.

The division member 34a on the cooling medium supply source side, and the division members 34b on the pipe 110 side are fastened by bolts, and therefore one of the division member 34a and each division member 34b may be provided with a long hole that is long in the radial direction of the pipe 110, and the other of the division member 34a and each division member 34b may be provided with a circular hole. Consequently, installation positions of the division members 34b, that is, the extending and contracting length of the plate material 34 can be finely adjusted on site.

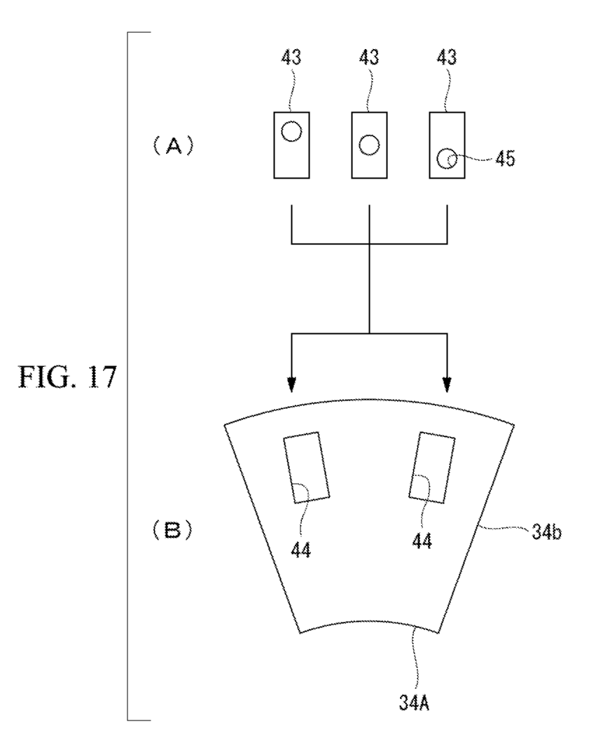

In a joining method of the division member 34a and the division members 34b, as illustrated in FIG. 17, openings 44 enabling fitting of a plurality of kinds of spacers 43 previously prepared may be formed in one of the division member 34a and the division members 34b. FIG. 17(B) illustrates a case where the openings 44 are formed in the division member 34b. The spacers 43 are formed such that positions of bolt holes 45 are different along the radial direction of the pipe 110 for respective kinds, as illustrated in FIG. 17(A). The spacers 43 to be fitted in the openings 44 are selected such that the bolt holes 45 are at suitable positions in the radial direction of the pipe 110. Consequently, extending and contracting length of the plate materials 34 can be changed by simply replacing the spacers 43, and the division members 34a, 34b can be reliably fixed.

While the temperature of the plate material 34 is low on the cooling medium supply source side, the pipe 110 is thermally expanded by allowing the high temperature fluid to flow therein, and therefore the radius of curvature of the pipe 110 becomes larger than an end 34A of the plate material 34. While the thermal expansion of the pipe 110 is previously considered, the plate material 34 may be manufactured such that the radius of curvature of the end 34A of the plate material 34 is larger than the radius of curvature of the pipe 110 at the time of a low temperature. Consequently, when the temperature of the pipe 110 is increased to expand the pipe thermally and the radius of curvature of the pipe 110 is increased, it is possible to reduce a gap formed between the end 34A of the plate material 34 and the pipe 110.

The division member 34b of the plate material 34 having the divided structure may have a configuration of being always urged toward the pipe 110 in the radial direction of the pipe 110. Consequently, even when the pipe 110 is thermally expanded by allowing the high temperature fluid to flow therein and the radius of curvature of the pipe 110 becomes larger, the end 34A of the plate material 34 can move by following the outer peripheral surface of the pipe 110. In this case, as illustrated in FIG. 16, a spacer 46 is provided between the end 34A of the plate material 34 and the outer peripheral surface of the pipe 110 such that an opening area of the outlet of the cooling medium outflow nozzle 33 is maintained. The spacers 46 are installed at a plurality of portions at intervals along the circumferential direction.

Examples of a means for urging the division member 34b of the plate material 34 toward the pipe 110 side include a spring member for pressing the division member 34b toward the pipe 110, and a band member having a ring-shaped elasticity fastening an outer peripheral side end 34b1 (refer to FIG. 16) of the division member 34b. The division member 34b may be urged toward the pipe 110 by providing a magnet in the spacer 46 installed in the end 34A of the division member 34b illustrated in FIG. 16.

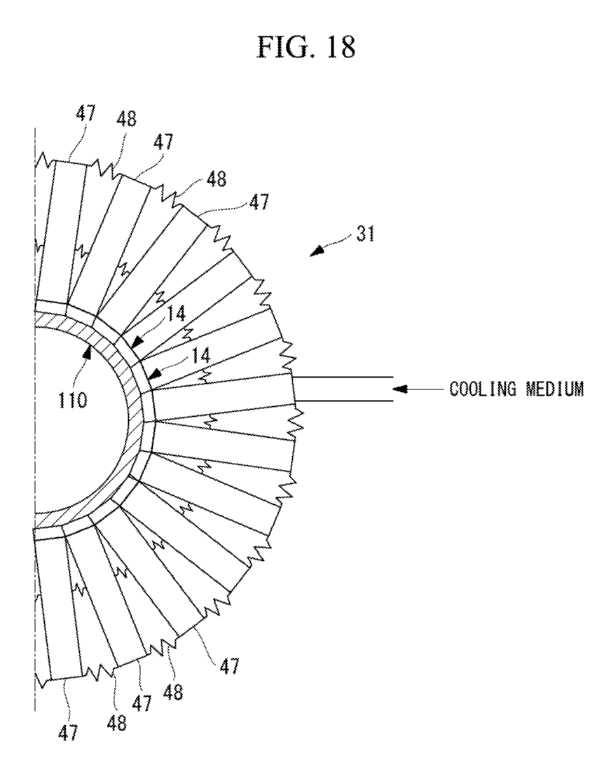

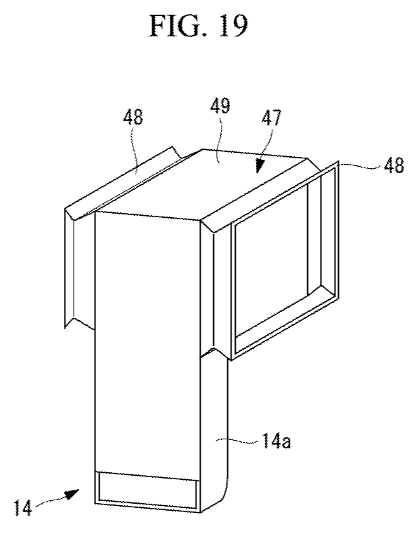

In the above embodiment and the modification, the cooling medium supply header 31 and the plate material 34 each have a ring shape, and are an integrated member continuously formed in the circumferential direction of the pipe 110, as illustrated in FIG. 6, or a member that is divided into a plurality of pieces to be combined, as illustrated in FIG. 10. The present invention is not limited to these examples. For example, as illustrated in FIG. 18 and FIG. 19, the cooling medium supply header 31 may be composed of a plurality of header units 47, and a plurality of bellows ducts 48 that couple the header units 47. The bellows ducts 48 each are an example of an extendable part. The header units 47 and the bellows ducts 48 are alternately coupled.

The plurality of header units 47 and the plurality of bellows ducts 48 can be coupled in the linear direction. The number of combinations of the plurality of header units 47 and the plurality of bellows ducts 48 are determined in accordance with the outer peripheral length of the pipe 110, and the length is adjusted. The coupled header units 47 and bellows ducts 48 are wound along the outer peripheral of the pipe 110, and thereafter first ends and second ends are coupled to form a ring shape.

The respective numbers of the header units 47 and the bellows ducts 48 are preferably previously prepared in accordance with the pipe 110 having an estimated maximum diameter.

Accordingly, even in a case where a damage portion needs to be quickly cooled, for example, when a portion having a high pipe damage risk is detected by a non-destructive test in a period of high power demand, the cooling medium supply header 31 is quickly manufactured to quickly cool the portion, thereby extending life of the damaged pipe 110 to improve reliability of the plant.

As in FIG. 19, each header unit 47 has a header part 49 and an outflow part 14. The outflow part 14 side in contact with the pipe 110 is formed from a heat resistant member, for example, stainless steel, and the header part 49 side whose temperature is near a normal temperature is formed from a lightweight member, for example, aluminum alloy.

Consequently, it is possible to reduce the weight of the whole cooling medium supply header 31. The header part 49 and the outflow part 14 side are different kinds of materials, and therefore are coupled by caulking or a rivet, for example.

The outflow part 14 of each header unit 47 has a closed structure by side end surfaces 14a in the header units 47, for example, and the header part 49 side is coupled by the bellows ducts 48. Alternatively, the outflow part 14 of each header unit 47 may have a structure of being coupled by the bellows duct to enable circulation of a cooling medium. Each bellows duct 48 coupled on the header part 49 side is disposed under a condition of a nearly room temperature, and therefore may be manufactured not by metal but by sheet-like synthetic resin having a heat-resisting property.

The cooling medium supply header 31 and the plate material 34 are composed of the plurality of header units 47, and the plurality of bellows ducts 48 that couple the header units 47, so that even in a case of the high-temperature pipe 110 having a different outer diameter, it is possible to easily mount the cooling medium supply header 31 on the pipe 110 without changing a structure of the cooling medium supply header 31. Because of coupling by the bellows ducts 48, following of thermal deformation of the pipe 110 is enabled. Furthermore, this configuration is applicable not only to the cooling medium supply header 31 disposed in a ring shape along the circumferential direction of the pipe 110, but also to the cooling medium supply header 11 disposed along the pipe axial direction of the pipe 110 when linearly disposed.

In this modification, description has been made to the case where the bellows ducts 48 are provided. However, bellows structure is not always provided, and intervals between the header units 47 only need to be coupled by adjustable members. For example, sheet members made of cloth, made of metal, or made of rubber may be provided in place of the bellows ducts 48.

### Second Embodiment

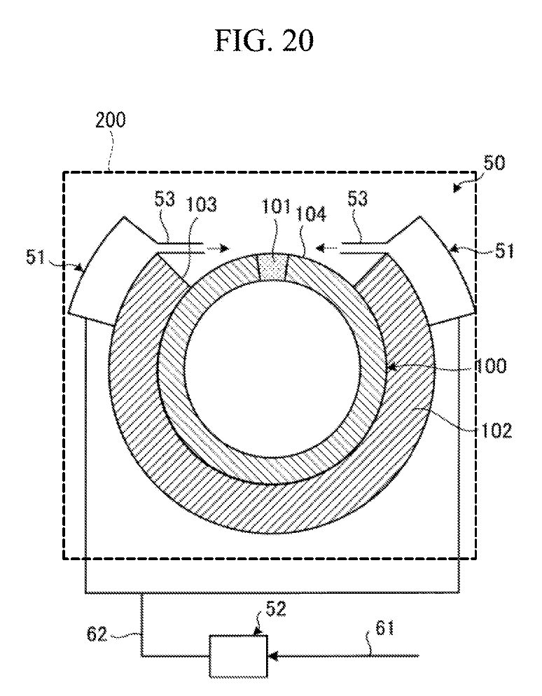

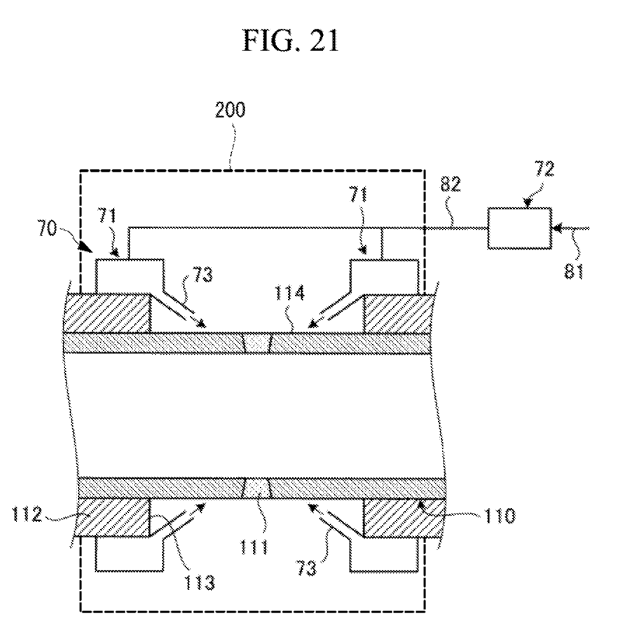

FIG. 20 is a schematic diagram illustrating a cooling device for a high temperature pipe of a second embodiment, and FIG. 21 is a schematic diagram illustrating a first modification of the cooling device for a high temperature pipe of the second embodiment. Members having similar functions as the members of the above first embodiment are denoted by the same reference numerals, and detailed description is omitted.

In the second embodiment, as illustrated in FIG. 20, a cooling device 50 for a high temperature pipe cools a surface to be cooled 104 of a metallic pipe 100, and includes cooling medium supply headers 51, a cooling medium supply device 52, cooling medium outflow nozzles 53, and a hood 200.

The cooling medium supply headers 51 are disposed so as not to shield heat dissipation by radiation from the surface to be cooled 104 of the pipe 100. The respective cooling medium supply headers 51 are disposed on both sides in the circumferential direction in an uncovered part 103 of a heat insulating material 102, and are supported so as to be placed on an outer peripheral surface of this heat insulating material 102.

The respective cooling medium supply headers 51 are provided on the both sides in the circumferential direction in the uncovered part 103 of the heat insulating material 102 such that the cooling medium outflow nozzles 53 face each other. The cooling medium outflow nozzles 53 extend toward an outer peripheral surface of the pipe 100 along end surfaces of the heat insulating material 102 forming this uncovered part 103 on sides close to the uncovered part 113 of the cooling medium supply headers 51, and have tip parts inclined to the outer peripheral surface of the pipe 100 so as to be directed to a welded part 101. Therefore, the respective cooling medium outflow nozzles 53 are disposed such that outlets face each other, and allow cooling mediums to flow out toward the welded part 101 in the surface to be cooled 104.

The cooling medium supply device 52 is a fan or a blower, and supplies the cooling medium to each cooling medium supply header 51. The cooling medium supply device 52 is coupled to an intake pipe 61, and is coupled up to the respective cooling medium supply headers 51 through a supply pipe 62. Therefore, the cooling medium supply device 52 supplies the cooling medium taken from the intake pipe 61 to the cooling medium supply headers 51 by the supply pipe 62.

Therefore, when the cooling medium supply device 52 is operated, and the cooling medium is taken in through the intake pipe 61, and the cooling medium is supplied to the respective cooling medium supply headers 51 through the supply pipe 62. Each cooling medium supply header 51 allows the cooling medium to flow out from each cooling medium outflow nozzle 53 toward the welded part 101 in the surface to be cooled 104. As a result, the welded part 101 is cooled with a high heat transfer coefficient by the cooling medium flowing out, and therefore it is possible to improve cooling efficiency.

In a first modification, as illustrated in FIG. 21, a cooling device 70 cools a surface to be cooled 114 of a metallic pipe 110, and includes cooling medium supply headers 71, a cooling medium supply device 72, cooling medium outflow nozzles 73, and a hood 200.

The cooling medium supply headers 71 are disposed so as not to shield heat dissipation by radiation from the surface to be cooled 114 of the pipe 110. The respective cooling medium supply headers 71 are supported so as to be placed on an outer peripheral surface of a heat insulating material 112.

In the respective cooling medium supply headers 71, the cooling medium outflow nozzles 73 are provided on facing sides so as to face each other. The cooling medium outflow nozzles 73 extend toward an outer peripheral surface of the pipe 110 along end surfaces of the heat insulating material 112 forming an uncovered part 113, on sides close to the uncovered part 113 of the cooling medium supply headers 71, and have tip parts inclined to the outer peripheral surface of the pipe 110 so as to be directed to a welded part 111. Therefore, the respective cooling medium outflow nozzles 73 are disposed such that outlets face each other, and allow cooling mediums to flow out toward the welded part 111 in the surface to be cooled 104.

The cooling medium supply device 72 is a fan or a blower, and supplies the cooling medium to each cooling medium supply header 71. The cooling medium supply device 72 is coupled to an intake pipe 81, and is coupled up to the respective cooling medium supply headers 71 through a supply pipe 82. Therefore, the cooling medium supply device 72 supplies the cooling medium taken from the intake pipe 81 to the respective cooling medium supply headers 71 by the supply pipe 82.

Therefore, when the cooling medium supply device 72 is operated, the cooling medium is taken in through the intake pipe 81, the cooling medium is supplied to the respective cooling medium supply headers 71 through the supply pipe 82. Each cooling medium supply header 71 allows the cooling medium to flow out from the each cooling medium outflow nozzle 73 toward the welded part 111 of the surface to be cooled 114, and the welded part 111 is cooled with a high heat transfer coefficient by the cooling medium flowing out.

Thus, in the cooling devices for a high temperature pipe of the second embodiment, cooling devices 50, 70 for a high temperature pipe that cool the surfaces to be cooled 104, 114 of the pipes 100, 110 include the cooling medium supply headers 51, 71 that are disposed so as not to shield heat dissipation by radiation from the surfaces to be cooled 104, 114, the cooling medium supply device 52, 72 that supply the respective cooling mediums to the cooling medium supply headers 51, 71, and the cooling medium outflow nozzles 53, 73 that allow the respective cooling mediums of the cooling medium supply headers 51, 71 toward the surfaces to be cooled 104, 114. In the cooling devices for a high temperature pipe of the second embodiment, the cooling medium supply headers 51, 71 are disposed on the both sides along the surfaces to be cooled 104, 114. However, in a case where the high temperature pipes are small diameter pipes, the cooling medium supply headers 51, 71 may be disposed on only one sides.

Therefore, when the cooling medium supply device 52, 72 supply the respective cooling mediums to the cooling medium supply headers 51, 71, the respective cooling mediums are supplied to these cooling medium supply headers 51, 71, the respective cooling mediums of the cooling medium supply headers 51, 71 flow out from the cooling medium outflow nozzles 53, 73 toward the surfaces to be cooled 104, 114, and cool the surfaces to be cooled 104, 114 of the pipes 100, 110 with a high heat transfer coefficient. At this time, the cooling medium supply headers 51, 71 are disposed so as not to shield heat dissipation by radiation from the surfaces to be cooled 104, 114, and therefore the outsides of the surfaces to be cooled 104, 114 have open spaces. Heat dissipation amounts by radiation are thus maximized, and therefore it is possible to suppress the cooling medium amounts, and effectively cool the pipes 100, 110.

In the cooling devices for a high temperature pipe of the second embodiment, the cooling medium outflow nozzles 53, 73 allow the respective cooling mediums to flow out toward the welded part 101, 111. Accordingly, the respective cooling mediums cool the welded part 101, 111 having high creep damage risk with a heat transfer coefficient, and therefore it is possible to efficiently cool the surfaces to be cooled 104, 114.

In the above embodiments, the cooling medium outflow nozzles 13, 33 allow the respective cooling mediums to flow out along the surfaces to be cooled 104, 114, or the cooling medium outflow nozzles 53, 73 allow the respective cooling mediums to flow out toward the welded part 101, 111. However, the present invention is not limited to these configurations. For example, the cooling medium outflow nozzles may allow the cooling mediums to flow out toward the surfaces to be cooled 104, 114, and supply the cooling mediums along the welded part 101, 111.

In the above embodiments, the cooling medium amount to the cooling medium supply header is controlled in accordance with an ambient air temperature or the temperature of the surface to be cooled. However, the cooling medium amount to the cooling medium supply header may be controlled by considering wind velocity or weather such as rain.

The cooling medium is air in the above embodiments, but may be inert gas such as nitrogen gas.

### REFERENCE SIGNS LIST

10 cooling device
11 cooling medium supply header
12 cooling medium supply device
13 cooling medium outflow nozzle
14 outflow part
14a side end surface
21 intake pipe
22 supply pipe
23 first temperature sensor
24 second temperature sensor
25 control device
30 cooling device
31 cooling medium supply header
31A division member
31B division member
31C division member
31a flange part
32 cooling medium supply device
33 cooling medium outflow nozzle
34 plate material
34A end
34a division member
34b division member
34b1 outer peripheral side end
35 slit
36 metallic foil
37 support material
37a first member
37b second member
37c wire material
38 curved part
39 bolt
40 nut
41 intake pipe
42 supply pipe
43 spacer
44 opening
45 bolt hole
46 spacer
47 header unit
48 bellows duct
49 header part
50 cooling device
51 cooling medium supply header
52 cooling medium supply device
53 cooling medium outflow nozzle
61 intake pipe
62 supply pipe
70 cooling device
71 cooling medium supply header
72 cooling medium supply device
73 cooling medium outflow nozzle
81 intake pipe
82 supply pipe
100 pipe
101 welded part
102 heat insulating material
103 uncovered part
104 surface to be cooled
110 pipe
111 welded part
112 heat insulating material
113 uncovered part
114 surface to be cooled
200 hood
H height of outlet
L cooling length
W welded portion

1. A cooling device for a high temperature pipe installed on a periphery of a surface to be cooled of a high temperature pipe, the cooling device for a high temperature pipe comprising:
a cooling medium supply header that is disposed at such a position as not to shield heat dissipation by radiation from the surface to be cooled to the periphery, and allows a cooling medium to flow out toward the surface to be cooled; and
a cooling medium supply device that supplies the cooling medium to the cooling medium supply header.

2. The cooling device for a high temperature pipe according to claim 1, wherein
the surface to be cooled is an exposed surface of the high temperature pipe exposed from an uncovered part of a heat insulating material that covers the high temperature pipe, and the cooling medium supply header is disposed outside the surface to be cooled.

3. The cooling device for a high temperature pipe according to claim 2, wherein
the cooling medium supply header is supported on an outer surface of the heat insulating material.

4. The cooling device for a high temperature pipe according to claim 2, wherein
the cooling medium supply header is supported on the high temperature pipe and an outer surface of the heat insulating material by a support member.

5. The cooling device for a high temperature pipe according to claim 1, further comprising:
a cooling medium outflow nozzle that allows the cooling medium of the cooling medium supply header to flow out toward the surface to be cooled.

6. The cooling device for a high temperature pipe according to claim 5, wherein
the cooling medium outflow nozzle allows the cooling medium to flow out along the surface to be cooled.

7. The cooling device for a high temperature pipe according to claim 5, wherein
the surface to be cooled includes a welded part, and the cooling medium outflow nozzle allows the cooling medium to flow out toward the welded part.

8. The cooling device for a high temperature pipe according to claim 1, wherein
the cooling medium supply header is provided with a cooling medium outlet that allows the cooling medium of the cooling medium supply header to flow out toward the surface to be cooled, the cooling medium supply header has a plate material provided along an uncovered part of a heat insulating material that covers the high temperature pipe, and the cooling medium outlet is formed from both an end of the plate material on a side close to the high temperature pipe and a surface of the high temperature pipe.

9. The cooling device for a high temperature pipe according to claim 1, wherein
the cooling medium supply header has a plate material provided along an uncovered part of a heat insulating material that covers the high temperature pipe, and
the plate material has a slit formed therein extending outward from a side close to the high temperature pipe.

10. The cooling device for a high temperature pipe according to claim 1, wherein
the cooling medium supply header has a plate material provided along an uncovered part of a heat insulating material that covers the high temperature pipe, and
the plate material is made up of an assembly of a plurality of division members divided along a circumferential direction of the high temperature pipe.

11. The cooling device for a high temperature pipe according to claim 1, wherein
the cooling medium supply header has a plate material provided along an uncovered part of a heat insulating material that covers the high temperature pipe, and
the plate material is made up of an assembly of a plurality of division members divided along the high temperature pipe, and is adjustable in a position of an end of the plate material on a side close to the high temperature pipe.

12. The cooling device for a high temperature pipe according to claim 1, wherein
the cooling medium supply header has:
a plurality of header units that allow the cooling medium to flow out toward the surface to be cooled while the cooling medium circulates; and
extendable parts that are provided between each two of the header units, and the header units and the extendable parts are alternately coupled.

13. The cooling device for a high temperature pipe according to claim 5, further comprising:
a temperature sensor that measures a temperature of the cooling medium supplied to the cooling medium supply header by the cooling medium supply device; and
a control device that controls an outflow amount of the cooling medium that is allowed to flow out toward the surface to be cooled from the cooling medium outflow nozzle or the cooling medium outlet, in accordance with the temperature of the cooling medium measured by the temperature sensor.

14. The cooling device for a high temperature pipe according to claim 5, further comprising:
a temperature sensor that measures a temperature of the surface to be cooled; and
a control device that controls an outflow amount of the cooling medium that is allowed to flow out toward the surface to be cooled from the cooling medium outflow nozzle or the cooling medium outlet, in accordance with the temperature of the surface to be cooled measured by the temperature sensor.
